(19) United States
(12) Patent Application Publication
(10) Pub. No.: US 2018/0227656 A1
(43) Pub. Date: Aug. 9, 2018

(54) Speaker Enhancer-Clarity S

(71) Applicant: Travis Towns, Philadelphia, PA (US)

(72) Inventor: Travis Towns, Philadelphia, PA (US)

(21) Appl. No.: 15/888,859

(22) Filed: Feb. 5, 2018

Related U.S. Application Data
(60) Provisional application No. 62/455,457, filed on Feb. 6, 2017.

(51) Int. Cl. H04R 1/08; H04R 1/04; H04R 3/00

(52) U.S. Cl. CPC H04R 1/083; H04R 1/04; H04R 2499/11; H04R 2420/09; H04R 3/00

(57) ABSTRACT

A speaker and microphone device comprising: a main body including an interior volume; a speaker member; a microphone member; and an electrical wire. Wherein the speaker and microphone device is adapted and used to provide an improved speaker member than one incorporated in the communication device; and wherein the speaker and microphone device is adapted and used to provide an improved microphone member than one incorporated in the communication device, such that a user can communicate more clearly when using the communication device. A combination is also disclosed of a communication device and a speaker and microphone device, comprising: a communication device and a speaker and microphone device. The communication device includes: a speaker member; a microphone member; and an audio connector.

### CROSS-REFERENCE TO RELATED APPLICATION

The present application is related to and claims priority from prior provisional application Ser. No. 62/455,457, filed Feb. 6, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of external speaker devices and more specifically relates to a speaker and microphone device adapted and used to provide an improved speaker member for cellular phones that serves as an external speaker to provide phone users with a device that improves the clarity of sound, as well as the volume when using the speaker function, while also encouraging safer phone usage.

### 2. Description of the Related Art

One the most explosive new technologies to come out of the last twenty years is the cellular telephone. In 1994, 16 million Americans were subscribers to cellular phone services. By 2002, that number had ballooned to more than 110 million, and still shows no sign of slowing down. In fact, some experts predict that worldwide subscribership will reach 1.4 billion people by the end of 2014. The basic concept of cellular phones began in 1947, when AT&T researchers sought ways to increase the traffic capacity and frequency of mobile communication in police car radios.

However, nonexistent technology and stringent FCC regulations postponed availability until 1982, when the FCC authorized commercial cellular use. As a result of this regulation, the scientific advances of the intervening years and increased competition among communications companies put the cellular telephone on the fast track. Today's widespread use of these revolutionary devices is unsurprising, since they now offer a virtually endless array of benefits. In addition to serving as a practical means of communication while on the go, technological advances have evolved cell phones into mini computers. Capable of keeping consumers abreast of the latest stock quotes, providing wireless Internet access, capturing photos and videos, enabling social networking, and playing music and games, in addition to many other features, cellular and digital telephones have become practically indispensable to millions the world over.

With the increased dependence on cellular telephone technology, it is important to consumers to find more practical and convenient ways to use these necessary devices. One practical, and encouraged, way of communicating via mobile phones is through the device's speaker function. With the touch of a button, one can speak into the phone and listen to the caller without the need to continually hold the phone in the hand. However, even the most advanced of phones do not produce quality sound, as the small internal speaker can only create a tinny, garbled noise that can, more often than not, be difficult to understand. As a result, frustrated users find themselves constantly asking the caller to repeat what was said. Add in surrounding noise such as moving vehicles and windy weather, and communication in this manner is essentially impossible. While a Bluetooth earpiece can assist in this problem, its sound quality is not much better, and many are loathe to experience the discomfort of an instrument shoved into the ear canal.

Various attempts have been made to solve problems found in external speaker device art. Among these are found in: U.S. Publication No. 20010053228 to Owen Jones; U.S. Publication No. 5117461 to William T. Moseley; and U.S. Patent No. 20140243048 to Chiman Kwan. This prior art is representative of a speaker enhancing and noise cancellation apparatus which may be externally connected to a mobile phone.

Ideally, a speaker and microphone device should be user-friendly and safe in-use and, yet should operate reliably and be manufactured at a modest expense. Thus, a need exists for a speaker and microphone device adapted and used to provide an improved speaker member for cellular phones that serves as an external speaker to provide phone users with a device that improves the clarity of sound, as well as the volume when using the speaker function, while also encouraging safer phone usage and to avoid the above-mentioned problems.

### BRIEF SUMMARY OF THE INVENTION

In view of the foregoing disadvantages inherent in the known external speaker devices art, the present invention provides a Speaker and Microphone Device (Entitled the Speaker Enhancer-Clarity S). The general purpose of the present invention, which will be described subsequently in greater detail is to provide a speaker and microphone device adapted and used to provide an improved speaker member for cellular phones that serves as an external speaker to provide phone users with a device that improves the clarity of sound, as well as the volume when using the speaker function, while also encouraging safer phone usage.

A speaker and microphone device comprising: a main body including an interior volume; a speaker member; a microphone member; and an electrical wire. The speaker member is located within the interior volume of the main body. The microphone member is located within the interior volume of the main body. The electrical wire is connected to the speaker member. The electrical wire is connected to the microphone member; and wherein the electrical wire extends outwardly from said main body and is adapted to releasably connect to an audio connector of a communication device. Wherein the speaker and microphone device is adapted and used to provide an improved speaker member than one incorporated in the communication device; and wherein the speaker and microphone device is adapted and used to provide an improved microphone member than one incorporated in the communication device, such that a user can communicate more clearly when using the communication device.

A combination is also disclosed of a communication device and a speaker and microphone device, comprising: a communication device and a speaker and microphone device. The communication device includes: a speaker member; a microphone member; and an audio connector.

The present invention holds significant improvements and serves as a Speaker and Microphone Device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Speaker and Microphone Device (Entitled the Speaker Enhancer-Clarity S) constructed and operative according to the teachings of the present invention.

FIG. 1 shows a perspective view illustrating an Speaker and Microphone Device according to an embodiment of the present invention.

FIG. 2 is a perspective view illustrating of the combination of a communication device and a speaker and microphone device according to an embodiment of the present invention according to an embodiment of the present invention of FIG. 1

FIG. 3 is a perspective view illustrating of the combination of a communication device and a speaker and microphone device in an in-use condition according to an embodiment of the present invention according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to external speaker devices and more specifically relates to a Speaker and Microphone Device (Entitled the Speaker Enhancer-Clarity S). The general purpose of the present invention, which will be described subsequently in greater detail is to provide a speaker and microphone device adapted and used to provide an improved speaker member for cellular phones that serves as an external speaker to provide phone users with a device that improves the clarity of sound, as well as the volume when using the speaker function, while also encouraging safer phone usage

Generally speaking, the Speaker Enhancer-Clarity S comprises a specially designed compact, portable external speaker device enhanced with improved sound capabilities. The Speaker Enhancer-Clarity S would be a cylindrical unit, measuring approximately one inch (1″) in length and one-half inch (½″) in width. Featuring a durable plastic casing, the body of the Enhancer would feature a combination of an audio speaker and a powerful microphone; as such, one would be able to speak into the device as well as clearly hear responses.

Extending downward, a flexible wire would culminate in a connection plug, featuring a universal jack that accommodates the headset port of almost any phone model. Relatively simple in design yet extremely effective in intended application, The Speaker Enhancer-Clarity S can be ready to use in a manner of seconds. Upon placing or receiving a call, a user would simply plug in the Enhancer, and continue the conversation.

The speaker is able to produce crystal clear sound, and the second party is able to clearly hear the person talking into The Speaker Enhancer-Clarity S device. As this product is highly portable, it can be easily used while attending to household chores, taking a walk, and especially, while operating a motor vehicle, offering safe, hands-free operation that allows a driver to keep attention focused on the road, and not juggling a device in one hand while trying to decipher the words being spoken through the phone. Eliminating the need to use uncomfortable earpieces, the handy Speaker Enhancer would ensure comfort and clarity for all who depend on hands-free mobile communication.

The Speaker Enhancer-Clarity S is a creative and practical product concept which would readily enhance the convenience of cellular telephones. Whether in the home or in a vehicle, this handy product would efficiently and expediently improve sound quality and facilitate clear communication. In addition, audio stemming from music files or video, etc., would also be clearly enhanced, and easier to hear. Affordably priced, The Speaker Enhancer-Clarity S should be well received by the vast number of consumers who depend on cellular telephones, an extremely sizable market potential.

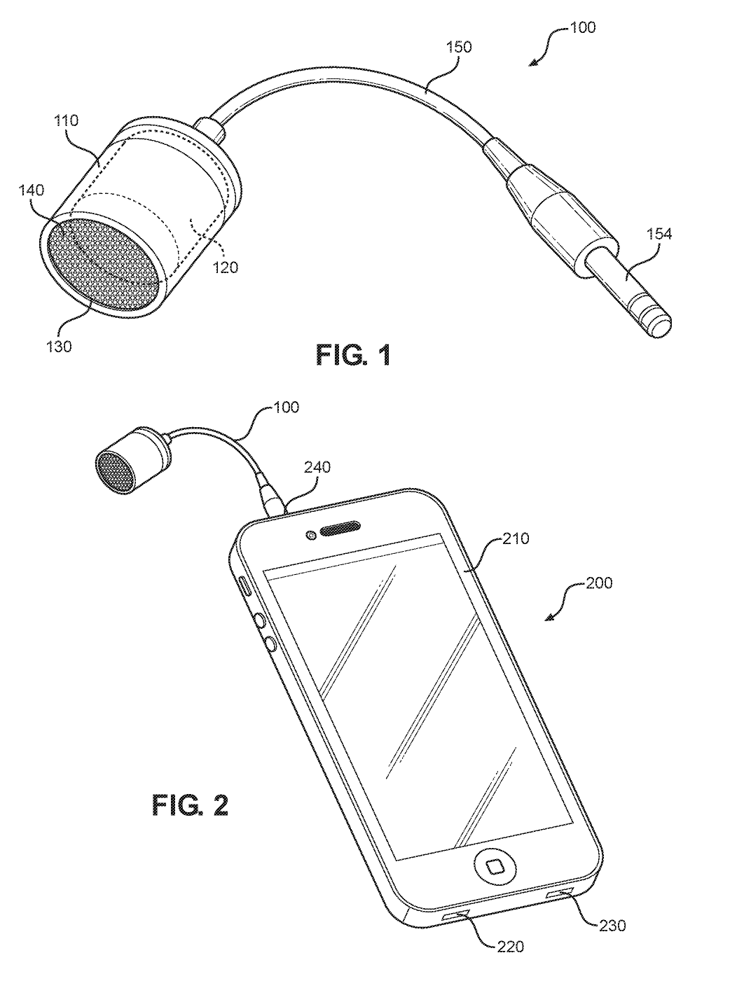

Referring to the drawings by numerals of reference there is shown in FIG. 1, shows a perspective view illustrating a Speaker and Microphone Device 100 according to an embodiment of the present invention.

A speaker and microphone device 100 is disclosed herein in a preferred embodiment comprising: main body 110 including interior volume 120; speaker member 130; microphone member 140; and electrical wire 150. Speaker member 130 is located within interior volume 120 of main body 110. Microphone member 140 is located within interior volume 120 of main body 110. Wherein main body 110 has cylindrical shape. Wherein main body 110 is formed from a rigid material. Wherein the rigid material is chosen from a list of rigid materials consisting of plastic and metal. Wherein main body 110 is 1 inch in length and ½ inch in width.

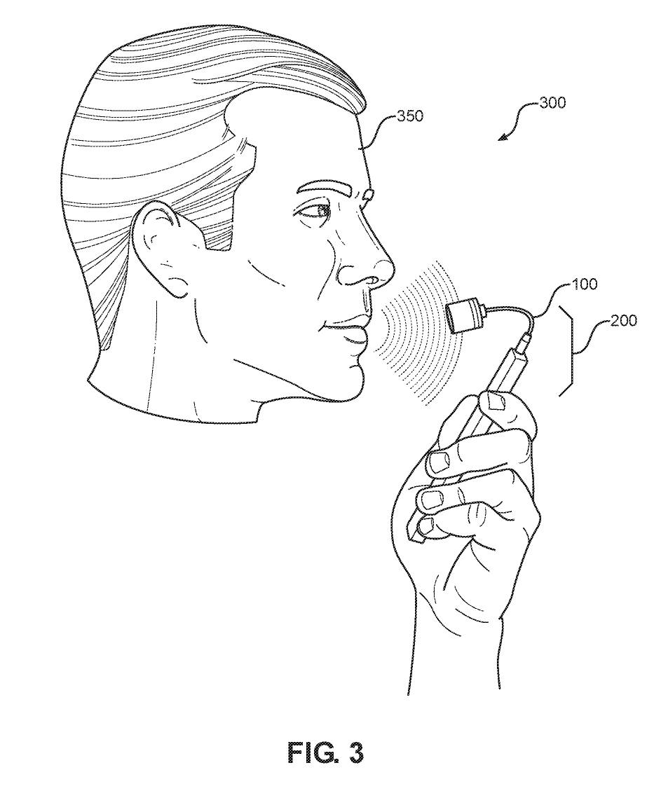

Electrical wire 150 is connected to speaker member 130. Electrical wire 150 is connected to microphone member 140; and wherein electrical wire 150 extends outwardly from main body 110 and is adapted to releasably connect to audio connector 240 of communication device 210. Wherein electrical wire 150 includes connection plug 154 at a distal end thereof adapted to removably connected to audio connector 240 of communication device 210. Wherein electrical wire 150 and connection plug 154 are adapted to receive and send audio signals between microphone member 140, speaker member 130, and communication device 210. Wherein connection plug 154 is formed as a ⅛ inch audio jack.

Wherein speaker and microphone device 100 is adapted and used to provide an improved speaker member 130 than one incorporated in communication device 210; and wherein speaker and microphone device 100 is adapted and used to provide improved microphone member 140 than one incorporated in communication device 210, such that user 350 can communicate more clearly when using communication device 210 as shown in in-use condition 300 of FIG. 3.

Referring to the drawings by numerals of reference there is shown in FIGS. 2 & 3, shows a perspective view illustrating combination 200 of communication device 210 and speaker and microphone device 100 according to an embodiment of the present invention.

Combination 200 of communication device 210 and speaker and microphone device 100, comprising: communication device 210 and speaker and microphone device 100. Communication device 210 includes: speaker member 220; microphone member 230; and audio connector 240.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A speaker and microphone device comprising:
a main body including:
an interior volume;
a speaker member;
wherein said speaker member is located within said interior volume of said main body;
a microphone member;
wherein said microphone member is located within said interior volume of said main body;
an electrical wire;
wherein said electrical wire is connected to said speaker member;
wherein said electrical wire is connected to said microphone member;
and wherein said electrical wire extends outwardly from said main body and is adapted to releasably connect to an audio connector of a communication device;
wherein said speaker and microphone device is adapted and used to provide an improved speaker member than one incorporated in said communication device;
and wherein said speaker and microphone device is adapted and used to provide an improved microphone member than one incorporated in said communication device, such that a user can communicate more clearly when using said communication device.

2. The speaker and microphone device of claim 1, wherein said main body has cylindrical shape.

3. The speaker and microphone device of claim 1, wherein said main body is formed from a rigid material.

4. The speaker and microphone device of claim 3, wherein said rigid material is chosen from a list of rigid materials consisting of plastic and metal.

5. The speaker and microphone device of claim 2, wherein said main body is 1 inch in length and ½ inch in width.

6. The speaker and microphone device of claim 1, wherein said electrical wire includes a connection plug at a distal end thereof adapted to removably connected to said audio connector of said communication device.

7. The speaker and microphone device of claim 6, wherein said electrical wire and said connection plug are adapted to receive and send audio signals between said microphone member, said speaker member, and said communication device.

8. The speaker and microphone device of claim 6, wherein said connection plug is formed as a ⅛ inch audio jack.

9. A combination of a communication device and a speaker and microphone device, comprising:
a communication device including:
a speaker member;
a microphone member; and
an audio connector; and
a speaker and microphone device comprising:
a main body including:
an interior volume;
a speaker member;
wherein said speaker member is located within said interior volume of said main body;
a microphone member;
wherein said microphone member is located within said interior volume of said main body;
an electrical wire;
wherein said electrical wire is connected to said speaker member;
wherein said electrical wire is connected to said microphone member;
and wherein said electrical wire extends outwardly from said main body and is adapted to releasably connect to said audio connector of said communication device;
wherein said speaker and microphone device is adapted and used to provide an improved speaker member than said speaker member of said communication device; and wherein said speaker and microphone device is adapted and used to provide an improved microphone member than said microphone member of said communication device, such that a user can communicate more clearly when using said communication device.

10. The combination of claim 9, wherein said main body has cylindrical shape.

11. The combination of claim 9, wherein said main body is formed from a rigid material.

12. The combination of claim 11, wherein said rigid material is chosen from a list of rigid materials consisting of plastic and metal.

13. The combination of claim 10, wherein said main body is 1 inch in length and ½ inch in width.

14. The combination of claim 9, wherein said electrical wire includes a connection plug at a distal end thereof adapted to removably connected to said audio connector of said communication device.

15. The combination of claim 14, wherein said electrical wire and said connection plug are adapted to receive and send audio signals between said microphone member, said speaker member, and said communication device.

16. The speaker and microphone device of claim 14, wherein said connection plug is formed as a ⅛ inch audio jack.
